(19) United States
(12) Patent Application Publication
(10) Pub. No.: US 2024/0039569 A1
(43) Pub. Date: Feb. 1, 2024

(54) SIGNAL RECEIVER AND SIGNAL RECEIVING METHOD

(71) Applicant: Realtek Semiconductor Corporation, Hsinchu (TW)

(72) Inventors: Ying-Rong SU, Hsinchu (TW); I-Ju CHEN, Hsinchu (TW); Kuan-Yu SHIH, Hsinchu (TW)

(21) Appl. No.: 18/357,152

(22) Filed: Jul. 23, 2023

(30) Foreign Application Priority Data
Jul. 28, 2022 (TW) 111128387

(51) Int. Cl. H04B 1/16; H04B 1/12

(52) U.S. Cl. CPC H04B 1/1615; H04B 1/12

(57) ABSTRACT

A signal receiving method, comprising: receiving a first communication signal and/or a second communication signal through an antenna; when the antenna receives the first communication signal and the second communication signal simultaneously, transmitting, by a first receiving circuit, the first communication signal to a first amplifying circuit, and receiving the second communication signal by a second receiving circuit; and When the antenna does not receive the first communication signal and the second communication signal simultaneously, transmitting, by the first receiving circuit, the first communication signal to the first amplifying circuit, and transmitting, by the first receiving circuit, the second communication signal to a second amplifying circuit. The first communication signal and the second communication signal correspond to different communication protocols respectively.

### CROSS-REFERENCE TO RELATED APPLICATION

This application claims priority to Taiwan Application Serial Number 111128387, filed Jul. 28, 2022, which is herein incorporated by reference in its entirety.

### BACKGROUND

### Technical Field

The present disclosure relates to techniques for receiving wireless signals, especially to a signal receiver configured to simultaneously receive different types of signals by at least one antenna.

### Description of Related Art

A signal receiver (RF Receiver) is a device used to receive wireless signals. In order to receive signals of different wireless communication protocols, signal receivers are equipped with multiple antennas to receive signals of different frequency bands simultaneously. However, when designing a product, if the number of antennas can be reduced, the cost and the overall size can be effectively reduced. Therefore, an important issue at present is to maintain the accuracy of the received signal while reducing the number of antennas.

### SUMMARY

One aspect of the present disclosure is a signal receiver, comprising an antenna, a first receiving circuit, a switch circuit and a second receiving circuit. The first receiving circuit is coupled to the antenna. The first receiving circuit is further coupled to a first amplifying circuit and a second amplifying circuit. The switch circuit is coupled to the antenna and the first receiving circuit. The second receiving circuit is coupled to the antenna though the switch circuit. When the signal receiver is configured to receive a first communication signal and a second communication signal simultaneously, the switch circuit is turned on so that the first amplifying circuit processes the first communication signal and the second receiving circuit receives the second communication signal through the switch circuit and the antenna. Wherein when the signal receiver is configured to receive one of the first communication signal and the second communication signal, the switch circuit is turned off, the signal receiver controls the first amplifying circuit to process the first communication signal, and controls the second amplifying circuit to process the second communication signal. The first communication signal and the second communication signal correspond to different communication protocols respectively.

Another aspect of the present disclosure is a signal receiving method, comprising: receiving a first communication signal and/or a second communication signal through an antenna; when the antenna receives the first communication signal and the second communication signal simultaneously, transmitting the first communication signal to a first amplifying circuit by a first receiving circuit, and receiving the second communication signal by a second receiving circuit; and when the antenna does not receive the first communication signal and the second communication signal simultaneously, transmitting the first communication signal to the first amplifying circuit by the first receiving circuit, and transmitting, by the first receiving circuit, the second communication signal to a second amplifying circuit.

Another aspect of the present disclosure is a signal receiver, comprising an antenna, a first receiving circuit, and a second receiving circuit. The first receiving circuit is coupled to the antenna to transmit and receive signals. The first receiving circuit is further coupled to a first amplifying circuit and a second amplifying circuit. The second receiving circuit is coupled to the antenna. When the signal receiver is configured to receive a first communication signal and a second communication signal simultaneously, the signal receiver turns off the second amplifying circuit so that the first amplifying circuit transmits the first communication signal to a processing unit and the second receiving circuit transmits the second communication signal to the processing unit. When the signal receiver is configured to receive one of the first communication signal and the second communication signal, the second receiving circuit is turned off, the signal receiver controls the first amplifying circuit to transmit the first communication signal to the processing unit, and controls the second amplifying circuit to transmit the second communication signal to the processing unit. The first communication signal and the second communication signal correspond to different communication protocols respectively.

It is to be understood that both the foregoing general description and the following detailed description are by examples, and are intended to provide further explanation of the disclosure as claimed.

### BRIEF DESCRIPTION OF THE DRAWINGS

The present disclosure can be more fully understood by reading the following detailed description of the embodiment, with reference made to the accompanying drawings as follows:

FIG. 1 is a schematic diagram of a signal receiver in some embodiments of the present disclosure.

FIG. 2 is a flowchart illustrating of signal receiving method in some embodiments of the present disclosure.

FIG. 3 is a schematic diagram of a signal receiver in some embodiments of the present disclosure.

### DETAILED DESCRIPTION

For the embodiment below is described in detail with the accompanying drawings, embodiments are not provided to limit the scope of the present disclosure. Moreover, the operation of the described structure is not for limiting the order of implementation. Any device with equivalent functions that is produced from a structure formed by a recombination of elements is all covered by the scope of the present disclosure. Drawings are for the purpose of illustration only, and not plotted in accordance with the original size.

It will be understood that when an element is referred to as being “connected to” or “coupled to”, it can be directly connected or coupled to the other element or intervening elements may be present. In contrast, when an element to another element is referred to as being “directly connected” or “directly coupled,” there are no intervening elements present. As used herein, the term “and/or” includes an associated listed items or any and all combinations of more.

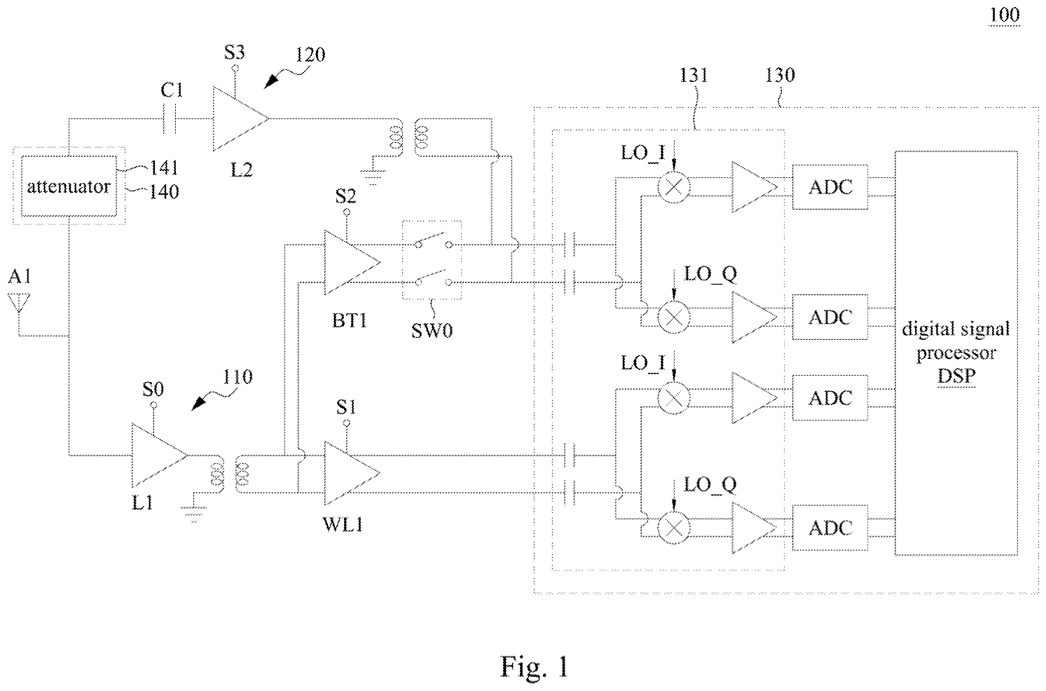

FIG. 1 is a schematic diagram of a signal receiver 100 in some embodiments of the present disclosure. The signal receiver 100 includes an antenna A1, a first receiving circuit 110 and a second receiving circuit 120. The first receiving circuit 110 and the second receiving circuit 120 is respectively coupled to the antenna A1, is configured to receive signals by the antenna A1.

In some embodiments, the signal receiver 100 further includes a processing unit 130, the processing unit 130 is coupled to the first receiving circuit 110 and the second receiving circuit 120, and is configured to process signals received by the first receiving circuit 110 and the second receiving circuit 120, such as converting an analog signal to a digital signal.

In one embodiment, the antenna A1 is configured to receive many different types of signals, such as wireless network signals (e.g., WiFi) and/or Bluetooth signals. In other words, the antenna A1 can receive a variety of communication signals corresponding to different communication protocols, and the corresponding bandwidths of the signals of different communication protocols are also different from each other. The antenna A1 can simultaneously receive communication signals corresponding to these different communication protocols, or sequentially receive communication signals corresponding to these different communication protocols at different time points. In different conditions, the signal receiver 100 selectively receives and processes communication signals corresponding to these different communication protocols in different ways.

Referring to FIG. 1, in one embodiment, the first receiving circuit 110 includes a low-noise amplifier L1. The second receiving circuit 120 includes a capacitor C1 and a low-noise amplifier L2 which are coupled to each other. The low-noise amplifiers L1, L2 is configured to amplify the received signal for the first time (referred to herein as “ first amplification process”) to reduce the influence of noise in the signal.

The low-noise amplifier L1 of the first receiving circuit 110 is coupled to a first amplifying circuit WL1 and a second amplifying circuit BT1 (e.g., through magnetic coupling). The first amplifying circuit WL1 and the second amplifying circuit BT1 can also implemented by low-noise amplifier. The low-noise amplifier L1 performs a second amplification process after the first amplification process (referred to herein as “second amplification process”). Specifically, the first amplifying circuit WL1 is configured to amplify the first communication signal (e.g., WiFi signal) received by the antenna A1. The low-noise amplifier L2 of the second receiving circuit 120 is coupled to the processing unit 130, the low-noise amplifier L2 and the second amplifying circuit BT1 is configured to receive the antenna A1 at different times/conditions, and are configured to amplify the second communication signal (e.g., Bluetooth signal) received by the antenna A1.

When the antenna A1 sequentially receives the first communication signal and the second communication signal (i.e., the antenna A1 only receives the one of the first communication signal and the second communication signal at the same time), the first receiving circuit 110 transmits the received first communication signal to the first amplifying circuit WL1, and transmits the received second communication signal to the second amplifying circuit BT1. The first amplifying circuit WL1 amplifies the first communication signal, and then transmits the amplified signal to the processing unit 130. Similarly, the second amplifying circuit BT1 amplifies the second communication signal, and then transmits the amplified signal to the processing unit 130. In other words, the first amplifying circuit WL1 and the second amplifying circuit BT1 are respectively configured to process signals corresponding to different communication protocols. For example, the first amplifying circuit WL1 is configured to process WiFi signals, and the second amplifying circuit BT1 is configured to process Bluetooth signals.

The aforementioned “transmitting signal” can be controlled by the processing unit 130 to turn on or off each circuit, so that the signal is received by the corresponding circuit. The control method will be described in the following paragraphs.

Specifically, the signal receiver 100 can selectively form an open circuit between the second amplifying circuit BT1 and the processing unit 130 by the switch SW0 (or form an open circuit between the antenna A1 and the second amplifying circuit BT1), so that the first communication signal is process by the first amplifying circuit WL1. In some other embodiments, when the antenna A1 receives the second communication signal, the control signal S1 of the first amplifying circuit WL1 is set to a disabled level to turn off the first amplifying circuit WL1. When the antenna A1 receives the first communication signal, the control signal S2 of the second amplifying circuit BT1 is set to a disable level to turn off the second amplifying circuit BT1. The control signals S1, S2 and the switch SW0 can all be controlled by the processing unit 130.

When the signal receiver 100 is configured to simultaneously receive the first communication signal and the second communication signal, the second amplifying circuit BT1 will be turned off. At this time, the first amplifying circuit WL1 transmit the first communication signal to the processing unit 130, and the low-noise amplifier L2 of the second receiving circuit 120 transmits the second communication signal to the processing unit 130. In other words, the first amplifying circuit WL1 and the second receiving circuit 120 is respectively configured to process signals of different communication protocols. For example, the first amplifying circuit WL1 is configured to process WiFi signals, and the low-noise amplifier L2 of the second receiving circuit 120 is configured to process Bluetooth signals. In addition, the low-noise amplifier L2 of the second receiving circuit 120 and the second amplifying circuit BT1 are two paths for processing bluetooth signals. The signal receiver 100 selectively processes the bluetooth signal by the second amplifying circuit BT1 or the low-noise amplifier L2 according to different conditions.

The aforementioned “sequentially receiving the first communication signal and the second communication signal” means that the interval between a time point when the antenna A1 receives the first communication signal and a time point when the antenna A1 receives the second communication signal is greater than a preset time, or the antenna A1 does not receive both of the first communication signal and the second communication signal in the preset time. Conversely, the aforementioned “simultaneously receive the first communication signal and the second communication signal” means that the interval between a time point when the antenna A1 receives the first communication signal and a time point when the antenna A1 receives the second communication signal is less than a preset time. In some embodiments, the signal receiver 100 determines whether the condition “simultaneously receive the first communication signal and the second communication signal” is matched based on “the time when the processing unit 130 receives the communication signal.”

As shown in FIG. 1, the low-noise amplifier L1, the first amplifying circuit WL1, the second amplifying circuit BT1 and the low-noise amplifier L2 are controlled by control signals S0, S1, S2, S3, respectively. Therefore, the processing unit 130 can select different circuits to process the signals received by the antenna A1 by changing the levels of the control signals S0-S3.

The signal receiver 100 of the present disclosure can selectively process the second communication signal by the second amplifying circuit BT1 or the low-noise amplifier L2 according to different conditions (i.e., receive signals corresponding to multiple communication protocols simultaneously, or receive signals of only one communication protocol at the same time). When the signal receiver 100 is configured to receive the first communication signal and the second communication signal simultaneously, the signal receiver 100 adjusts a first gain of the low-noise amplifier L1 in the first receiving circuit 110 according to a first signal strength of the first communication signal. Similarly, the signal receiver 100 adjusts a second gain of the low-noise amplifier L2 in the second receiving circuit 120 according to a second signal strength of the second communication signal.

On the other hand, when the signal receiver 100 is configured to receive the first communication signal and the second communication signal at different times, the signal receiver 100 adjusts the first gain of the low-noise amplifier L1 in the first receiving circuit 110 according to the currently received signal strength (the first signal strength of the first communication signal, or the second signal strength of the second communication signal).

When the signal receiver 100 receives the first communication signal and the second communication signal simultaneously, the difference between the strength of the first communication signal and the strength of the second communication signal can be huge. Therefore, if all signals are received by the low-noise amplifier L1 in the first receiving circuit 110, the first gain of the low-noise amplifier L1 in the first receiving circuit 110 cannot be adjusted properly, which may cause the first communication signal with weaker signal strength cannot be correctly received and analyzed. For example, when the strength of the second communication signal is much greater than the strength of the first communication signal, since the second communication signal is stronger, the signal receiver 100 does not need to greatly adjust the gain of the low-noise amplifier L1 of the first receiving circuit 110 so that the first communication signal with weak strength cannot be properly amplified. The present disclosure uses the second amplifying circuit BT1 and the low-noise amplifier L2 as two independent paths for receiving the second communication signal. Accordingly, the gains of the low-noise amplifier L1 and the low-noise amplifier L2 can be adjusted respectively according to the strengths of the first communication signal and the second communication signal.

In some embodiments, the signal receiver 100 further includes a switch circuit 140. The second receiving circuit 120 is coupled to the switch circuit 140, so as coupled to the antenna A1 though the switch circuit 140. When the signal receiver 100 receives the first communication signal and the second communication signal simultaneously, the switch circuit 140 is turned on, the first amplifying circuit WL1 receives the first communication signal by the first receiving circuit 110 and the antenna A1, and the second receiving circuit 120 receives the second communication signal by the switch circuit 140 and the antenna A1. On the other hand, when the signal receiver 100 only receives the first communication signal or the second communication signal, the switch circuit 140 is turned off, so that the first amplifying circuit WL1 receives the first communication signal, or the second amplifying circuit BT1 receives the second communication signal.

In one embodiment, the signal receiver 100 can also set the control signal S3 of the low-noise amplifier L2 in the second receiving circuit 120 to a disabled level when only the first communication signal or the second communication signal is received, so as to turn off the second receiving circuit 120.

In some other embodiments, the switch circuit 140 further includes an attenuator 141. The attenuator 141 is configured to reduce the strength of communication signal transmitted by the antenna A1 to the second receiving circuit 120. For example, the attenuator 141 can reduce the strength of the second communication signal with stronger strength from −50 dBm to −70 dBm, and filter the first communication signal with weaker strength. Accordingly, when the signal receiver 100 simultaneously receives the first communication signal and the second communication signal, it can be ensured that only the second communication signal with a stronger signal will be transmitted to the second receiving circuit 120.

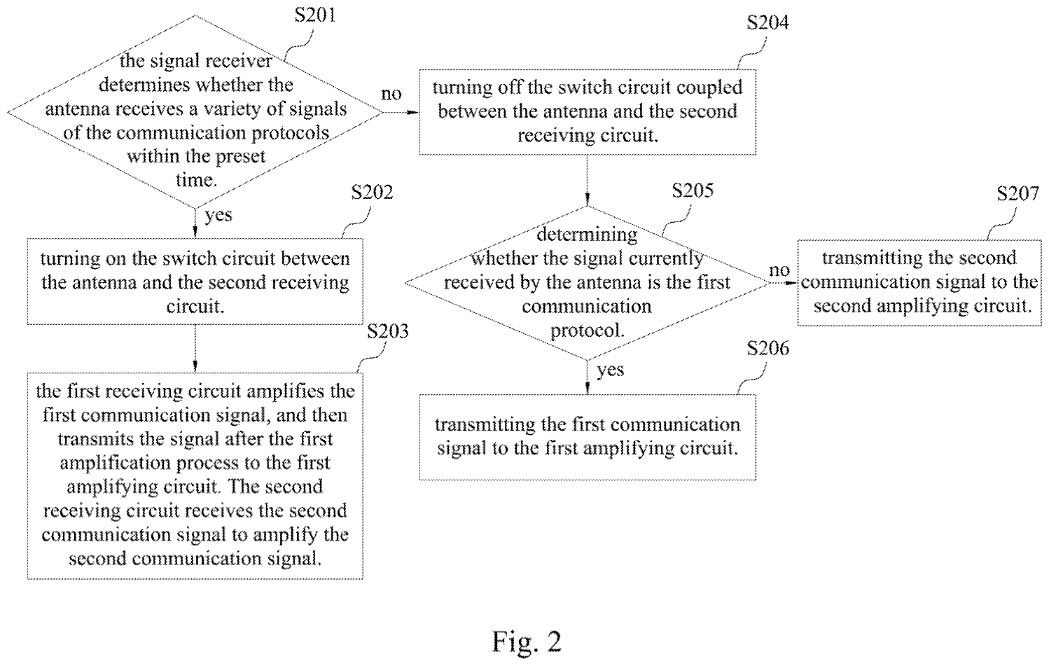

FIG. 2 is a flowchart illustrating of a signal receiving method in some embodiments of the present disclosure. In step S201, the signal receiver 100 determines whether the antenna A1 receives a variety of signals of the communication protocols (i.e., the first communication signal and the second communication signal) within the preset time.

If the antenna A1 receives the first communication signal and the second communication signal in the preset time, it means “the antenna A1 receives a variety of signals simultaneously”. At this time, in step S202, turning on the switch circuit 140 between the antenna A1 and the second receiving circuit 120. At the same time, turning off the second amplifying circuit BT1.

Next, in step S203, the low-noise amplifier L1 of the first receiving circuit 110 amplifies the first communication signal, and then transmits the signal after the first amplification process to the first amplifying circuit WL1. The low-noise amplifier L2 of the second receiving circuit 120 receives the second communication signal to amplify the second communication signal.

If the antenna A1 does not receive both of the first communication signal and the second communication signal in the preset time, or the antenna A1 only receives one of the first communication signal and the second communication signal in the preset time, it means “the antenna A1 is not receiving a variety of signals simultaneously”. At this time, in step S204, turning off the switch circuit 140 coupled between the antenna A1 and the second receiving circuit 120 (e.g., controlled by the controller 132). As mentioned above, in other embodiments, the signal receiver 100 can also turn off the second receiving circuit 120 by setting the control signal S3 to a disabled level.

In step S205, determining whether the signal currently received by the antenna A1 is the first communication protocol. If the received signal is the first communication signal belonging to the first communication protocols, in step S206, turning off the second amplifying circuit BT1, and transmitting the first communication signal to the first amplifying circuit WL1 through the first receiving circuit 110 for amplification process. If the received signal is the second communication signal belonging to the second communication protocol, in step S207, turning off the first amplifying circuit WL1, and transmitting the second communication signal to the second amplifying circuit BT1 through the first receiving circuit 110 for amplification process.

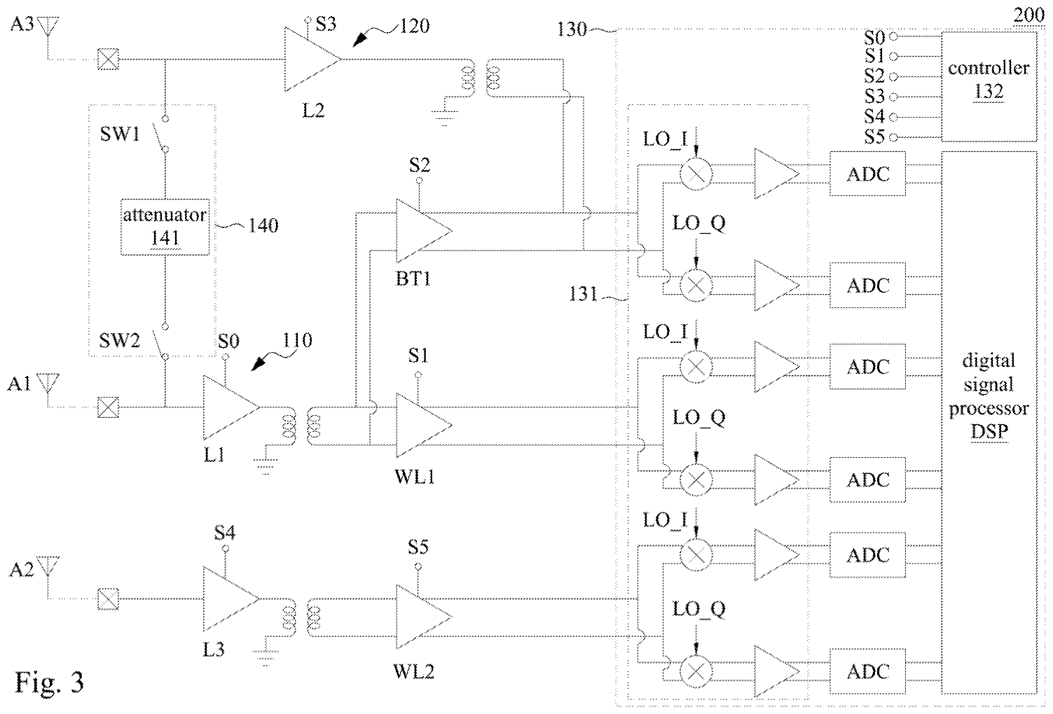

FIG. 3 is a schematic diagram of a signal receiver 200 in some embodiments of the present disclosure. In FIG. 3, the similar components associated with the embodiment of FIG. 1 are labeled with the same numerals for ease of understanding. The specific principle of the similar component has been explained in detail in the previous paragraphs, and unless it has a cooperative relationship with the components of FIG. 3, it is not repeated here.

In one embodiment, the signal receiver 200 includes multiple antennas A1, A2, a third receiving circuit L3 and a third amplifying circuit WL2. The antenna A2 is configured to receive a first communication signal of first communication protocols (e.g., WiFi). For example, when the signal receiver 200 does not need to receive the first communication signal of the first communication protocols, the third receiving circuit L3 and the third amplifying circuit WL2 will be turned off. The third receiving circuit L3 and the third amplifying circuit WL2 can also be implemented by the low-noise amplifier. In other words, when the signal receiver 200 only needs to receive the first communication signal, the performance of transmitting and receiving signals can be improved through multiple antennas such as the antenna A1 and the antenna A2. The antenna A2 is configured to transmit the first communication signal to the third receiving circuit L3 and the third amplifying circuit WL2 for amplification process.

In addition, in some embodiments, the signal receiver 200 further includes an antenna A3. The antenna A3 is coupled to the second receiving circuit 120. The second receiving circuit 120 is respectively coupled to the antenna A1 and the antenna A3, so as to selectively receive the second communication signal by the antenna A1 or the antenna A3. As shown in FIG. 3, when the signal receiver 200 is provided with the antenna A3, the signal receiver 200 can receive the first communication signal by the antenna A1 and receive the second communication signal by the antenna A3. At this time, the switch circuit 140 and the second amplifying circuit BT1 are turned off. On the other hand, if the antenna A3 is removed from the signal receiver 200 (e.g., due to cost or volume considerations), the switch circuit 140 will be selectively turned on, the signal receiver 200 will process the first communication signal and the second communication signal in the manner of the embodiment shown in FIG. 1.

In the foregoing embodiments, the processing unit 130 includes a frequency reduction circuit 131, multiple analog-to-digital conversion circuits ADC, a digital signal processor DSP and a controller 132. The frequency reduction circuit 131 is configured to convert (demodulate) the received signal from a high frequency signal to a low frequency signal. For example, the frequency of the first communication signal is 2412 MHz and the bandwidth is 20 MHz (e.g., 2402-2422 MHz), the frequency reduction circuit 131 is configured to reduce the frequency of the first communication signal to 10 MHz to −10 MHz. In some embodiments, the frequency reduction circuit 131 receives high-frequency signals LO_I, LO_Q generated by a local oscillator (not shown in figure) through a plurality of down converters, so as to demodulate the received signal. The high-frequency signals LO_I, LO_Q are clock signals with a phase difference of 90 degrees, which are used to decompose and restore a composite signal (e.g., the first communication signal) into two independent signals. Similarly, the second communication signal can also be decompose into two independent signals.

The analog-to-digital conversion circuit ADC is coupled to the frequency reduction circuit 131, so as to receive the first communication signal and the second communication signal (e.g., receive the analog signal down-converted by the frequency reduction circuit 131) from the first amplifying circuit WL1, the second amplifying circuit BT1, the second receiving circuit 120 and the third amplifying circuit WL2, and performs analog-to-digital conversion. For example, converting the signal from the first amplifying circuit WL1, the second amplifying circuit BT1, the second receiving circuit 120 or the low-noise amplifier L2 of the third amplifying circuit WL2 to digital format. The digital signal processor DSP is configured to perform corresponding operations according to the demodulated digital signal. Since one skilled in art can understand the operation principles of the frequency reduction circuit 131, the analog-to-digital conversion circuit ADC and the digital signal processor DSP, it will not be repeated here.

The controller 132 is coupled to the first receiving circuit 110, the second receiving circuit 120, the first amplifying circuit WL1, the second amplifying circuit BT1, the third receiving circuit L3, the third amplifying circuit WL2 and the switch SW1, SW2 of the switch circuit 140, and is configured to control the turn-on or turn-off of these circuits respectively. In addition, the controller 132 is further coupled to the digital signal processor DSP, so as to determine whether the antenna A1 simultaneously receives the first communication signal and the second communication signal in the preset time according to the signal currently processed by the digital signal processor DSP. According to the result of determining, the controller selectively changes the levels of the control signals S0-S5 to control the turn-on or turn-off of the first receiving circuit 110, the second receiving circuit 120, the first amplifying circuit WL1, the second amplifying circuit BT1, the third receiving circuit L3, the third amplifying circuit WL2 and the switch circuit 140. Similarly, the controller 132 can also selectively turn on or turn off the switches SW1 and SW2 according to the current condition.

In the foregoing embodiments, the controller 132 is a part of the processing unit 130. In other embodiments, the controller 132 and the processing unit 130 are independent of each other. For example, the controller 132 can be implemented by the microprocessor of the electronic device which applied to the signal receiver 200, without being packaged in same body with the signal receiver 200.

The elements, method steps, or technical features in the foregoing embodiments may be combined with each other, and are not limited to the order of the specification description or the order of the drawings in the present disclosure.

It will be apparent to those skilled in the art that various modifications and variations can be made to the structure of the present disclosure without departing from the scope or spirit of the present disclosure. In view of the foregoing, it is intended that the present disclosure cover modifications and variations of this present disclosure provided they fall within the scope of the following claims.

What is claimed is:

1. A signal receiver, comprising:
an antenna;
a first receiving circuit coupled to the antenna, wherein the first receiving circuit is further coupled to a first amplifying circuit and a second amplifying circuit;
a switch circuit coupled to the antenna and the first receiving circuit; and
a second receiving circuit coupled to the antenna though the switch circuit;
wherein when the signal receiver is configured to receive a first communication signal and a second communication signal simultaneously, the switch circuit is turned on so that the first amplifying circuit processes the first communication signal and the second receiving circuit receives the second communication signal through the switch circuit and the antenna;
wherein when the signal receiver is configured to receive one of the first communication signal and the second communication signal, the switch circuit is turned off, the signal receiver controls the first amplifying circuit to process the first communication signal, and controls the second amplifying circuit to process the second communication signal, and
wherein the first communication signal and the second communication signal correspond to different communication protocols respectively.

2. The signal receiver of claim 1, wherein when the signal receiver is configured to receive the first communication signal and the second communication signal simultaneously, the second amplifying circuit is turned off.

3. The signal receiver of claim 1, wherein the switch circuit comprises an attenuator, the attenuator is configured to reduce a strength of the second communication signal transmitted by the antenna to the second receiving circuit.

4. The signal receiver of claim 1, wherein a bandwidth of the first communication signal and a bandwidth of the second communication signal are different.

5. The signal receiver of claim 1, further comprises:
a processing unit comprising an analog-to-digital conversion circuit, and configured to receive the first communication signal and the second communication signal from the first amplifying circuit, the second amplifying circuit and the second receiving circuit for performing analog-to-digital conversion.

6. The signal receiver of claim 5, wherein when the signal receiver is configured to receive the first communication signal and the second communication signal simultaneously, the processing unit is configured to adjust a first gain of the first receiving circuit according to a first signal strength of the first communication signal, and adjust a second gain of the second receiving circuit according to a second signal strength of the second communication signal.

7. A signal receiving method, comprising:
receiving a first communication signal and/or a second communication signal through an antenna;
when the antenna receives the first communication signal and the second communication signal simultaneously, transmitting the first communication signal to a first amplifying circuit by a first receiving circuit, and receiving the second communication signal by a second receiving circuit; and
when the antenna does not receive the first communication signal and the second communication signal simultaneously, transmitting the first communication signal to the first amplifying circuit by the first receiving circuit, and transmitting, by the first receiving circuit, the second communication signal to a second amplifying circuit.

8. The signal receiving method of claim 7, wherein receiving the second communication signal by the second receiving circuit comprises:
turning a switch circuit coupled between the antenna and the second receiving circuit.

9. The signal receiving method of claim 7, further comprising:
determining that the antenna does not receive the first communication signal and the second communication signal simultaneously by a controller, and turning off a switch circuit coupled between the antenna and the second receiving circuit.

10. The signal receiving method of claim 7, further comprising:
when the antenna receives the first communication signal and the second communication signal simultaneously, adjusting a first gain of the first receiving circuit according to a first signal strength of the first communication signal, and adjusting a second gain of the second receiving circuit according to a second signal strength of the second communication signal.

11. The signal receiving method of claim 7, further comprising:
Reducing, by an attenuator, a strength of the second communication signal transmitted by the antenna to the second receiving circuit.

12. A signal receiver, comprising:
an antenna;
a first receiving circuit coupled to the antenna to transmit and receive signals, wherein the first receiving circuit is further coupled to a first amplifying circuit and a second amplifying circuit; and
a second receiving circuit coupled to the antenna;
wherein when the signal receiver is configured to receive a first communication signal and a second communication signal simultaneously, the signal receiver turns off the second amplifying circuit so that the first amplifying circuit transmits the first communication signal to a processing unit and the second receiving circuit transmits the second communication signal to the processing unit;
wherein when the signal receiver is configured to receive one of the first communication signal and the second communication signal, the second receiving circuit is turned off, the signal receiver controls the first amplifying circuit to transmit the first communication signal to the processing unit, and controls the second amplifying circuit to transmit the second communication signal to the processing unit, and
wherein the first communication signal and the second communication signal correspond to different communication protocols respectively.

13. The signal receiver of claim 12, wherein the second receiving circuit is coupled to the antenna though a switch circuit, the switch circuit comprises an attenuator, the attenuator is configured to reduce a strength of the second communication signal transmitted by the antenna to the second receiving circuit.

14. The signal receiver of claim 12, wherein a bandwidth of the first communication signal and a bandwidth of the second communication signal are different.

15. The signal receiver of claim 12, wherein when the signal receiver is configured to receive the first communication signal and the second communication signal simultaneously, the signal receiver is configured to adjust a first gain of the first receiving circuit according to a first signal strength of the first communication signal, and adjust a second gain of the second receiving circuit according to a second signal strength of the second communication signal.
